(19) United States
(12) Patent Application Publication
(10) Pub. No.: US 2002/0141553 A1
(43) Pub. Date: Oct. 3, 2002

(54) Transmission line rerouting method, subscriber line accommodating apparatus and trunk transmission line accommodating apparatus

(76) Inventors: Shigeki Kurihara, Kawasaki (JP); Koji Yamamoto, Fukuoka (JP); Chikara Shibagaki, Fukuoka (JP)

Correspondence Address: KATTEN MUCHIN ZAVIS ROSENMAN, 575 MADISON AVENUE, NEW YORK, NY, 10022-2585, US

(21) Appl. No.: 09/940,055

(22) Filed: Aug. 27, 2001

(30) Foreign Application Priority Data
Mar. 29, 2001 (JP) 2001-097131

(51) Int. Cl. H04M 15/00

(52) U.S. Cl. 379/133; 379/112.01; 379/112.06; 379/112.08; 379/134; 379/137

(57) ABSTRACT

A transmission line rerouting method includes the steps of selecting a predetermined trunk transmission line to be rerouted, from trunk transmission lines, coupling a first subscriber line accommodating apparatus which is coupled to the predetermined trunk transmission line and a second subscriber line accommodating apparatus which is coupled to a trunk transmission line other than the predetermined trunk transmission line, via a rerouting transmission line, and transmitting and receiving a data which is to be exchanged between the first subscriber line accommodating apparatus and the trunk transmission line accommodating apparatus, via the second subscriber line accommodating apparatus and the trunk transmission line other than the predetermined trunk transmission line.

### BACKGROUND OF THE INVENTION

This application claims the benefit of a Japanese Patent Application No. 2001-097131 filed Mar. 29, 2001, in the Japanese Patent Office, the disclosure of which is hereby incorporated by reference.

1. Field of the Invention

The present invention generally relates to transmission line rerouting methods, subscriber line accommodating apparatuses and trunk transmission line accommodating apparatuses, and more particularly to a transmission line rerouting methods, a subscriber line accommodating apparatus and a trunk transmission line accommodating apparatus which are used in a digital transmission system.

2. Description of the Related Art

Recently, much attention is drawn to the x digital subscriber line (xDSL) system which is a digital transmission system using an existing telephone copper-wire cable (subscriber line) for telephones. The xDSL system provides a high-speed access line to the subscriber by utilizing bands up to a high frequency band on the order of several MHz.

According to the xDSL system, the distance of the telephone copper-wire cable and the frequency band have an inversely proportional relationship. Hence, in order to provide a high-speed xDSL, a network structure having a short telephone copper-wire cable must be used. For example, the telephone copper-wire cable can be made short as shown in FIG. 1, by providing a remote xDSL subscriber line accommodating apparatus near the subscriber's home.

FIG. 1 is a diagram showing an example of the network structure including the remote xDSL subscriber line accommodating apparatus. For example, a remote xDSL subscriber line accommodating apparatus 100 shown in FIG. 1 accommodates one or more xDSL modems which are set up at the subscriber's home by xDSLs. In addition, an accommodating station 110 connects and accommodates one or more remote xDSL subscriber line accommodating apparatuses 100 by a trunk transmission line 120. In order to cope with a situation where a failure or contention occurs in the trunk transmission line 120, the remote xDSL subscriber line accommodating apparatus 100 and the accommodating apparatus 110 are in many cases connected via a rerouting transmission line 130 which is other than the trunk transmission line 120 and has a transmission band equivalent to that of the trunk transmission line 120.

For example, it is conceivable for the rerouting transmission line 130 to utilize a line switching network such as INS proposed in a Japanese Laid-Open Patent Application No. 61-262338 or a Japanese Laid-Open Patent Application No. 5-75736. In addition, it is conceivable to regard an INS line used in these Japanese Laid-Open Patent Applications No. 61-262338 and No. 5-75736 as the xDSL, so that the xDSL is used as the rerouting transmission line 130. Furthermore, it is conceivable to use a wireless line proposed in a Japanese Laid-Open Patent Application No. 2000-124910 or the like as the rerouting transmission line 130.

However, when using the line switching network such as the INS proposed in the Japanese Laid-Open Patent Applications No. 61-262338 and No. 5-75736 for the rerouting transmission line 130, the maximum transmission rate becomes 64 kbps, and there is a problem in that it is impossible to secure the transmission rate for the xDSL service. In order to secure the transmission rate for the xDSL service using the INS line, it is necessary to terminate a large number of INS lines to form a multi-link, but there is a problem in that such a multi-link structure is expensive. In addition, if the kind of transmission line is different between the trunk transmission line 120 and the rerouting transmission line 130, there is a problem in that a gateway apparatus becomes necessary in the remote xDSL subscriber line accommodating apparatus 100 and the accommodating apparatus 110.

When the INS line of the Japanese Laid-Open Patent Applications No. 61-262338 and No. 5-75736 are regarded as the xDSL line, and the xDSL is used as the rerouting transmission line 130, the distance of the rerouting transmission line 130 becomes long compared to the distance of the xDSL (subscriber line). For this reason, the transmission rate of the rerouting transmission line 130 becomes low compared to the transmission rate of the xDSL, and there is a problem in that the transmission rate of the xDSL service cannot be secured. When securing the transmission rate of the xDSL service by forming a multi-link of a plurality of xDSLs, an extremely complex control becomes necessary, and there is a problem in that the apparatuses become expensive.

On the other hand, when using the wireless line of the Japanese Laid-Open Patent Application No. 2000-124910 as the rerouting transmission line 130, two kinds of interfaces must be provided in the remote xDSL subscriber line accommodating apparatus 100 and the accommodating apparatus 110, and there is a problem in that the apparatuses become expensive.

Therefore, the rerouting transmission line 130 must be provided with respect to the remote xDSL subscriber line accommodating apparatus 100 and the accommodating apparatus 110 in order to continue the service even when the failure or contention occurs in the trunk transmission line 120, but there is a problem in that the operation cost is increased thereby.

On the other hand, with respect to the remote xDSL subscriber line accommodating apparatus 100, the telephone copper-wire cable must be made short in order to provide a high-speed xDSL. Consequently, the number of subscribers which can be accommodated by one remote xDSL subscriber line accommodating apparatus 100 becomes small. In other words, the cost per subscriber accommodated by one remote xDSL subscriber line accommodating apparatus 100 increase.

Furthermore, the operation cost is increased considerably by providing the rerouting transmission line 130 for each remote xDSL subscriber line accommodating apparatus 100, and it is difficult to provide services at costs comparable to the costs of the services provided by other high-speed digital transmission systems.

Moreover, the subscribers which may be accommodated by one remote xDSL subscriber line accommodating apparatus 100 are limited to the subscribers within the same area, such as within the same building or apartment. As a result, the number of subscribers which can be accommodated varies depending on each area.

Accordingly, there is a problem in that the usable band greatly differs between the remote xDSL subscriber line accommodating apparatus 100 which accommodates a large number of subscribers and the xDSL subscriber line accommodating apparatus 10 which accommodates a small number of subscribers. SUMMARY OF THE INVENTION

Accordingly, it is a general object of the present invention to provide a novel and useful transmission line rerouting methods, subscriber line accommodating apparatus and trunk transmission line accommodating apparatus, in which the problems described above are eliminated.

Another and more specific object of the present invention to provide a transmission line rerouting methods, a subscriber line accommodating apparatus and a trunk transmission line accommodating apparatus, which can form an inexpensive rerouting transmission line without providing a backup trunk transmission line and suppress differences in the usable bands among the subscribers.

Still another object of the present invention is to provide a transmission line rerouting method for rerouting a predetermined trunk transmission line of a plurality of trunk transmission lines of a system in which a plurality of subscriber line accommodating apparatuses respectively accommodating one or more subscriber lines and a trunk transmission line accommodating apparatus accommodating the plurality of subscriber line accommodating apparatuses are coupled via the plurality of trunk transmission lines, comprising the steps of (a) selecting the predetermined trunk transmission line to be rerouted, from the plurality of trunk transmission lines; (b) coupling a first subscriber line accommodating apparatus which is coupled to the predetermined trunk transmission line and a second subscriber line accommodating apparatus which is coupled to a trunk transmission line other than the predetermined trunk transmission line, via a rerouting transmission line; and (c) transmitting and receiving a first data which is to be exchanged between the first subscriber line accommodating apparatus and the trunk transmission line accommodating apparatus, via the second subscriber line accommodating apparatus and the trunk transmission line other than the predetermined trunk transmission line. According to the transmission line rerouting method of the present invention, when the predetermined trunk transmission line to be rerouted is selected, the first subscriber line accommodating apparatus connected to the predetermined trunk transmission line and the second subscriber line accommodating apparatus connected to the trunk transmission line other than the predetermined trunk transmission line via the rerouting transmission line. In addition, by transmitting and receiving the first data which is to be transmitted and received between the first subscriber line accommodating apparatus and the trunk transmission line accommodating apparatus via the second subscriber line accommodating apparatus and the trunk transmission line other than the predetermined trunk transmission line, it is possible to prevent the trunk transmission line from becoming suspended for a long time. Moreover, the contention states of the trunk transmission lines can be made uniform, and it is possible to suppress a difference from being introduced in the bands available to each of the subscribers. Furthermore, it is possible to reduce the operating cost of the system and to provide inexpensive services, because the rerouting transmission line can be formed without the need to provide a backup trunk transmission line. On the other hand, since it is possible to form a rerouting transmission line having a transmission band equivalent to that of the predetermined trunk transmission line, it is possible to minimize the deterioration of the services even when the rerouting is carried out, and the reliability of the services can be secured.

A further object of the present invention is to provide a subscriber line accommodating apparatus for accommodating one or a plurality of subscriber lines, comprising trunk transmission line coupling means for coupling trunk transmission lines to a trunk transmission line accommodating apparatus which accommodates one or a plurality of subscriber line accommodating apparatuses; and transfer means for monitoring a state of the trunk transmission lines and transferring a first transmitting data which is to be transmitted to the trunk transmission line accommodating apparatus to an other subscriber line accommodating apparatus depending on a monitored result, so that a first receiving data which is to be received from the trunk transmission line accommodating apparatus is transferred from the other subscriber line accommodating apparatus. According to the subscriber line accommodating apparatus of the present invention, when the predetermined trunk transmission line to be rerouted is selected, the first subscriber line accommodating apparatus connected to the predetermined trunk transmission line and the second subscriber line accommodating apparatus connected to the trunk transmission line other than the predetermined trunk transmission line via the rerouting transmission line. In addition, by transmitting and receiving the first data which is to be transmitted and received between the first subscriber line accommodating apparatus and the trunk transmission line accommodating apparatus via the second subscriber line accommodating apparatus and the trunk transmission line other than the predetermined trunk transmission line, it is possible to prevent the trunk transmission line from becoming suspended for a long time. Moreover, the contention states of the trunk transmission lines can be made uniform, and it is possible to suppress a difference from being introduced in the bands available to each of the subscribers. Furthermore, it is possible to reduce the operating cost of the system and to provide inexpensive services, because the rerouting transmission line can be formed without the need to provide a backup trunk transmission line. On the other hand, since it is possible to form a rerouting transmission line having a transmission band equivalent to that of the predetermined trunk transmission line, it is possible to minimize the deterioration of the services even when the rerouting is carried out, and the reliability of the services can be secured.

Another object of the present invention is to provide a trunk transmission line accommodating apparatus for accommodating one or a plurality of subscriber line accommodating apparatuses, comprising trunk transmission line coupling means for coupling to the one or plurality of subscriber line accommodating apparatuses respectively accommodating one or more subscriber lines via one or more trunk transmission lines; and transmitting and receiving means for monitoring a state of the one or more trunk transmission lines and transferring a transmitting data which is to be transmitted to a first subscriber line accommodating apparatus to a second subscriber line accommodating apparatus depending on a monitored result, so that a receiving data which is to be received from the first subscriber line accommodating apparatus is received from the second subscriber line accommodating apparatus. According to the trunk transmission line accommodating apparatus of the present invention, when the predetermined trunk transmission line to be rerouted is selected, the first subscriber line accommodating apparatus connected to the predetermined trunk transmission line and the second subscriber line accommodating apparatus connected to the trunk transmission line other than the predetermined trunk transmission line via the rerouting transmission line. In addition, by transmitting and receiving the first data which is to be transmitted and received between the first subscriber line accommodating apparatus and the trunk transmission line accommodating apparatus via the second subscriber line accommodating apparatus and the trunk transmission line other than the predetermined trunk transmission line, it is possible to prevent the trunk transmission line from becoming suspended for a long time. Moreover, the contention states of the trunk transmission lines can be made uniform, and it is possible to suppress a difference from being introduced in the bands available to each of the subscribers. Furthermore, it is possible to reduce the operating cost of the system and to provide inexpensive services, because the rerouting transmission line can be formed without the need to provide a backup trunk transmission line. On the other hand, since it is possible to form a rerouting transmission line having a transmission band equivalent to that of the predetermined trunk transmission line, it is possible to minimize the deterioration of the services even when the rerouting is carried out, and the reliability of the services can be secured.

Other objects and further features of the present invention will be apparent from the following detailed description when read in conjunction with the accompanying drawings.

### BRIEF DESCRIPTION OF THE DRAWINGS

FIG. 1 is a diagram showing an example of a network structure including a remote xDSL subscriber line accommodating apparatus;

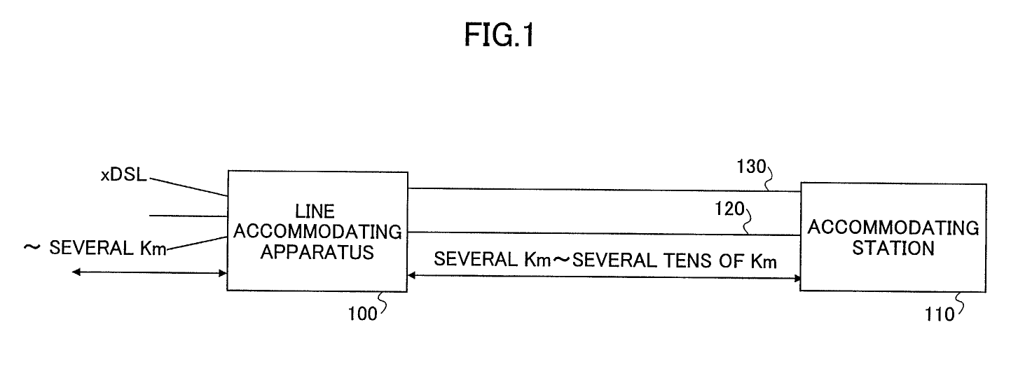

FIG. 2 is a diagram for explaining the operating principle of a transmission line rerouting method according to the present invention;

FIG. 3 is a system block diagram showing an embodiment of a remote xDSL subscriber line accommodating apparatus according to the present invention;

FIG. 4 is a system block diagram showing an embodiment of a system including the xDSL subscriber line accommodating apparatuses according to the present invention; and

FIG. 5 is a sequence diagram for explaining an embodiment of a transmission line rerouting procedure.

### DESCRIPTION OF THE PREFERRED EMBODIMENTS

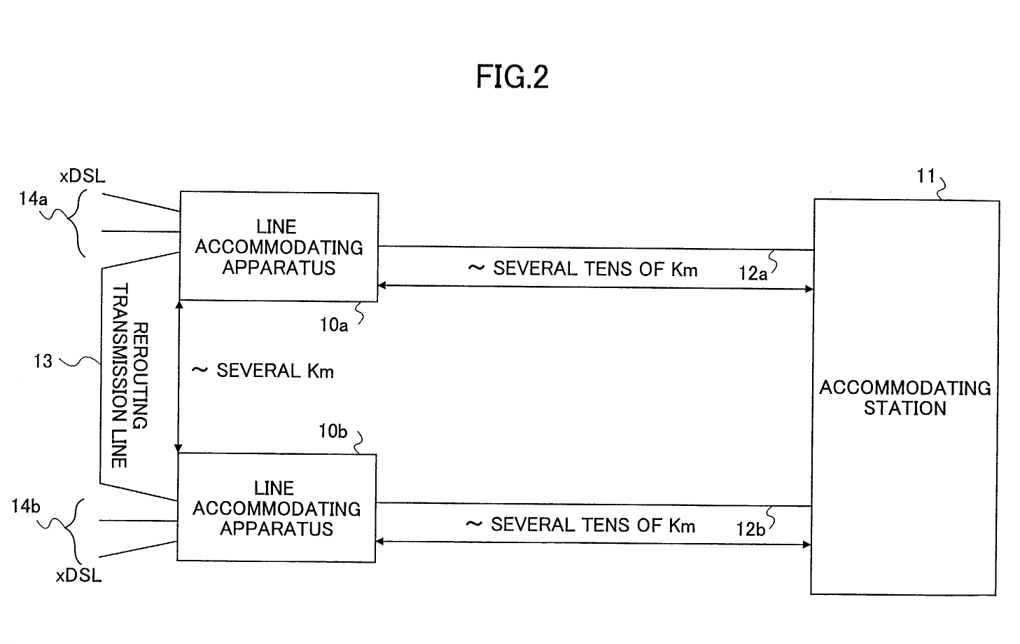

A description will be given of various embodiments of a transmission line rerouting method according to the present invention, a subscriber line accommodating apparatus according to the present invention, and a trunk transmission line accommodating apparatus according to the present invention, by referring to FIGS. 2 through 5. In the embodiments described hereunder, the xDSL is utilized as an example of the digital transmission system, but the present invention is of course applicable to any kind of digital transmission system.

First, a description will be given of the operating principle of the present invention, by referring to FIG. 2. FIG. 2 is a diagram for explaining the operating principle of the transmission line rerouting method according to the present invention. In FIG. 2, each of remote xDSL subscriber line accommodating apparatuses 10a and 10b accommodates one or more xDSL modems set up at the subscriber homes, for example, by connecting to a corresponding one of xDSLs 14a and 14b. In addition, an accommodating station 11 connects to and accommodates the remote xDSL subscriber line accommodating apparatuses 10a and 10b via respective trunk transmission lines 12a and 12b.

The remote xDSL subscriber line accommodating apparatus 10a and the remote xDSL subscriber line accommodating apparatus 10b are connected by a rerouting transmission line 13 using one or more xDSLs. The remote xDSL subscriber line accommodating apparatus 10a and the remote xDSL subscriber line accommodating apparatus 10b are set up within a separating distance of several km, for example, so that a required band may be secured for the rerouting transmission line 13.

When a failure or a contention occurs in one of the trunk transmission line 12a and the trunk transmission line 12b, the rerouting transmission line 13 is used to connect the remote xDSL subscriber line accommodating apparatus 10a or the remote xDSL subscriber line accommodating apparatus 10b to the accommodating station 11 via the other of the trunk transmission lines 12a and the trunk transmission line 12b in which no failure or contention is generated. For example, when the failure or contention (hereinafter simply referred to as an abnormality) occurs in the trunk transmission line 12b, for example, the remote xDSL subscriber line accommodating apparatus 10b is connected to the accommodating station 11 via the rerouting transmission line 13, the remote xDSL subscriber line accommodating apparatus 10a and the trunk transmission line 12a.

When using the xDSL as the rerouting transmission line 13, an interface required for the rerouting transmission line 13 can be realized by a slight modification to the hardware or the signal processing firmware, because the circuit of such an interface is similar to that of an interface which accommodates the subscriber line. Accordingly, the remote xDSL subscriber line accommodating apparatus 10a and the remote xDSL subscriber line accommodating apparatus 10b can utilize the xDSLs as the rerouting transmission line 13 by making the slight modification to the hardware or the signal processing firmware.

By employing as the xDSL a xDSL in which the up-transmission rate and the down-transmission rate are symmetrical, it becomes unnecessary to modify the setting on the center side or the remote side of the rerouting transmission line 13 when an abnormality is generated in the trunk transmission lines 12a and 12b, thereby making it possible to reduce a switching time which would otherwise be longer if the setting were to be modified.

When the trunk transmission lines 12a and 12b are in a normal state, the rerouting transmission line 13 is used to transfer control information between the remote xDSL subscriber line accommodating apparatus 10a and the remote xDSL subscriber line accommodating apparatus 10b. Hence, the remote xDSL subscriber line accommodating apparatuses 10a and 10b exchange with each other, through notification, control information which includes abnormality information of the trunk transmission lines 12a and 12b, switching request and the like, so that each of the remote xDSL subscriber line accommodating apparatuses 10a and 10b can independently carry out a transmission line rerouting process when an abnormality occurs in the trunk transmission line 12a or 12b.

In addition, control paths using the trunk transmission lines 12a and 12b, for example, may be set between the accommodating station 11 which accommodates the remote xDSL subscriber line accommodating apparatuses 10a and 10b and the remote xDSL subscriber line accommodating apparatuses 10a and 10b which are mutually connected via the rerouting transmission line 13. In this case, it is possible to independently carry out the transmission line rerouting process in the remote xDSL subscriber line accommodating apparatuses 10a and 10b and the accommodating station 11 when the abnormality is generated in the trunk transmission line 12a or 12b.

When using the xDSL in which the up-transmission rate and the down-transmission rate are asymmetrical, it becomes necessary to modify the setting at the center side or the remote side of the rerouting transmission line 13 when the abnormality is generated in the trunk transmission lines 12a and 12b. In this case, the remote xDSL subscriber line accommodating apparatuses 10a and 10b exchange with each other, through notification, control information which includes abnormality information of the trunk transmission lines 12a and 12b, switching request and the like, and modify the setting at the center side or the remote side of the rerouting transmission line 13 by disconnecting the rerouting transmission line 13. In other words, the setting can be modified at the center side or the remote side of the rerouting transmission line 13 depending on the direction in which the broad band is required, thereby making it possible to secure the band required for the rerouting transmission line 13.

In a case where the setting at the center side or the remote side of the rerouting transmission line 13 cannot be modified during operation, two xDSLs may be used as the rerouting transmission line 13. In this case, one xDSL may be set in advance as the center side and the other xDSL may be set in advance as the remote side, so as to realize a pseudo-state in which the same band is used for the two directions.

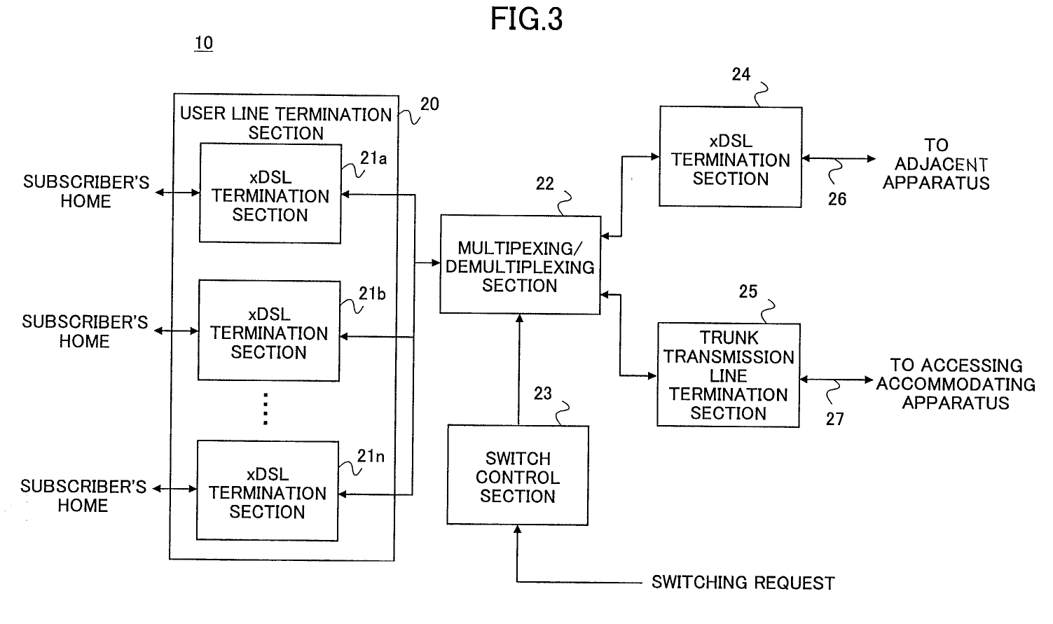

Next, a description will be given of the structures of the remote xDSL subscriber line accommodating apparatuses 10a and 10b, by referring to FIG. 3. FIG. 3 is a system block diagram showing an embodiment of the remote xDSL subscriber line accommodating apparatus which may be used as the remote xDSL subscriber line accommodating apparatuses 10a and 10b, that is, an embodiment of the subscriber line accommodating apparatus according to the present invention. A remote xDSL subscriber line accommodating apparatus 10 shown in FIG. 3 includes a user line termination section 20, a multiplexing and demultiplexing section 22, a switch control section 23, a xDSL termination section 24, and a trunk transmission line termination section 25.

The user line termination section 20 includes one or more xDSL termination sections 21a through 21n respectively terminating the xDSLs which are used as the user lines. In addition, the xDSL termination sections 21a through 21n are connected to the multiplexing and demultiplexing section 22.

The xDSL termination section 24 is connected to the xDSL termination section 24 of the adjacent remote xDSL subscriber line accommodating apparatus 10 via the xDSL 26, and terminates this xDSL 26. This xDSL 26 is used as the rerouting transmission line 13. The xDSL termination section 24 is connected to the multiplexing and demultiplexing section 22.

The trunk transmission line termination section 25 is connected to an accessing accommodating apparatus set up in the accommodating station 11 via a trunk transmission line 27, and terminates this trunk transmission line 27. The trunk transmission line termination section 25 is connected to the multiplexing and demultiplexing section 22.

The switch-control section 23 receives various switching requests from within or outside the remote xDSL subscriber line accommodating apparatus 10, and instructs switching of the multiplexing and demultiplexing section 22 depending on the switching request. The multiplexing and demultiplexing section 22 carries out a routing process among the user line termination section 20, the xDSL termination section 24 and the trunk transmission line termination section 25, depending on the switching instruction from the switching control section 23.

For example, when an abnormality is generated in the trunk transmission line 27 or when transferring a specific user line to another remote xDSL subscriber line accommodating apparatus 10, the switching request is generated inside or outside the remote xDSL subscriber line accommodating apparatus 10 and supplied to the switching control section 23. The switching request may be generated, for example, by an operation system provided outside the remote xDSL subscriber line accommodating apparatus 10 or, by a control unit provided inside the remote xDSL subscriber line accommodating apparatus 10. The control unit provided inside the remote xDSL subscriber line accommodating apparatus 10 generates the switching request by utilizing failure information and contention information of the trunk transmission line termination section 25, for example.

The multiplexing and demultiplexing section 22 changes a transfer destination of the data supplied from the user line from the trunk transmission line termination section 25 to the xDSL termination section 24, and changes a transfer destination of the data supplied from the xDSL 26 to the user line termination section 20, depending on the switching request received from the switching control section 23. Accordingly, when an abnormality is generated in the trunk transmission line 27, the remote xDSL subscriber line accommodating apparatus 10 can utilize the xDSL 26 as the rerouting transmission line.

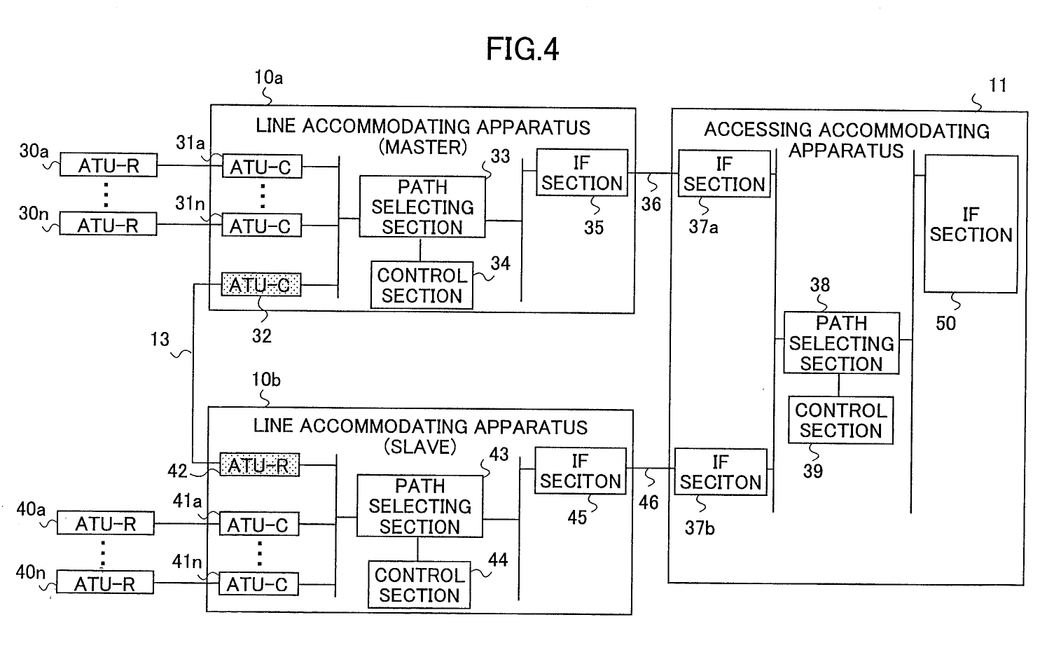

Next, a description will be given of a system including the remote xDSL subscriber line accommodating apparatuses 10 described above, by referring to FIG. 4. FIG. 4 is a system block diagram showing an embodiment of the system including the xDSL subscriber line accommodating apparatuses according to the present invention.

In FIG. 4, the remote xDSL subscriber line accommodating apparatus 10a includes xDSL termination sections 31a through 31n and 32, a path selecting section 33, a control section 34, and a transmission line interface (IF) section 35. Similarly, the remote xDSL subscriber line accommodating apparatus 10b includes xDSL termination sections 41a through 41n and 42, a path selecting section 43, a control section 44, and a transmission line interface (IF) section 45. The accessing accommodating apparatus 11 includes transmission line interface (IF) sections 37a and 37b, a path selecting section 38, a control section 39, and a backbone trunk interface (IF) section 50.

In FIG. 4, the path selecting sections 33 and 43 correspond to the multiplexing and demultiplexing section 22 shown in FIG. 3, and the control sections 34 and 44 correspond to the switching control section 23 shown in FIG. 3. In addition, the transmission line interface sections 35 and 45 shown in FIG. 4 correspond to the trunk transmission line termination section 25 shown in FIG. 3.

Two kinds of modes, namely, a master mode and a slave mode, may be set with respect to the remote xDSL subscriber line accommodating apparatuses 10a and 10b. In this embodiment, the remote xDSL subscriber line accommodating apparatus 10a is set to the master mode, and the remote xDSL subscriber line accommodating apparatus 10b is set to the slave mode. The xDSL termination section 32 of the remote xDSL subscriber line accommodating apparatus 10a which is set to the master mode operates in an ADSL transceiver unit at the central office (ATU-C) mode. In addition, the xDSL termination section 42 of the remote xDSL subscriber line accommodating apparatus 10b which is set to the slave mode operates in an ATU at the remote end (ATU-R) mode.

The xDSL termination section 32 and the xDSL termination section 42 are connected via the xDSL, and this xDSL is used as the rerouting transmission line 13. In FIG. 4, each xDSL termination section which operates in the ATU-C mode is indicated by a designation “ATU-C”. In addition, each xDSL termination section which operates in the ATU-R mode is indicated by a designation “ATU-R”.

The remote xDSL subscriber line accommodating apparatus 10a includes one or more xDSL termination sections 31a through 31n, and the xDSL termination sections 31a through 31n respectively accommodate xDSL termination sections 30a through 30n which are set up within the subscriber homes. The one or more xDSL termination sections 31a through 31n are connected to the path selecting section 33.

The demote xDSL subscriber line accommodating apparatus 10b includes one or more xDSL termination sections 41a through 41n, and the xDSL termination sections 41a through 41n respectively accommodate xDSL termination sections 40a through 40n which are set up within the subscriber homes. The one or more xDSL termination sections 41a through 41n are connected to the path selecting section 43.

The transmission interface section 35 of the remote xDSL subscriber line accommodating apparatus 10a is connected to a transmission line interface section 37a of the accessing accommodating apparatus 11 via a trunk transmission line 36. The transmission line interface section 35 is connected to the path selecting section 33. In addition, the transmission line interface section 45 of the remote xDSL subscriber line accommodating apparatus 10b is connected to a transmission line interface section 37b of the accessing accommodating apparatus 11 via a trunk transmission line 46. The transmission line interface section 45 is connected to the path selecting section 43.

The control section 34 of the remote xDSL subscriber line accommodating apparatus 10a receives various switching requests supplied from inside or outside the remote xDSL subscriber line accommodating apparatus 10a, and instructs switching of the path selecting section 33 depending on the switching request. The path selecting section 33 carries out a routing process among the xDSL termination sections 31a through 31n, the xDSL termination section 32 and the transmission line interface section 35, depending on the switching instruction from the control section 34.

The control section 44 of the remote xDSL subscriber line accommodating apparatus 10b receives various switching requests supplied from inside or outside the remote xDSL subscriber line accommodating apparatus 10b, and instructs switching of the path selecting section 43 depending on the switching request. The path selecting section 43 carries out a routing process among the xDSL termination sections 41a through 41n, the xDSL termination section 42 and the transmission line interface section 45, depending on the switching instruction from the control section 44.

The accessing accommodating apparatus 11 forms an embodiment of the trunk transmission line accommodating apparatus according to the present invention.

The transmission line interface sections 37a and 37b of the accessing accommodating apparatus 11 are connected to a path selecting section 38. A backbone trunk interface section 50 is connected to the path selecting section 38. A control section 39 of the accessing accommodating apparatus 11 receives various switching requests supplied from inside or outside the accessing accommodating apparatus 11, and instructs switching of the path selecting section 38 depending on the switching request. The path selecting section 38 carries out a routing process among the transmission line interface section 37a, the transmission line interface section 37b and the backbone trunk interface section 50, depending on the switching instruction from the control section 39.

A control path utilizing the rerouting transmission line 13 is set between the control section 34 of the remote xDSL subscriber line accommodating apparatus 10a and the control section 44 of the remote xDSL subscriber line accommodating apparatus 10b. In addition, control paths utilizing the trunk transmission lines 36 and 46 are set between the control section 39 of the accessing accommodating apparatus 11 and the control sections 34 and 44 of the remote xDSL subscriber line accommodating apparatuses 10a and 10b.

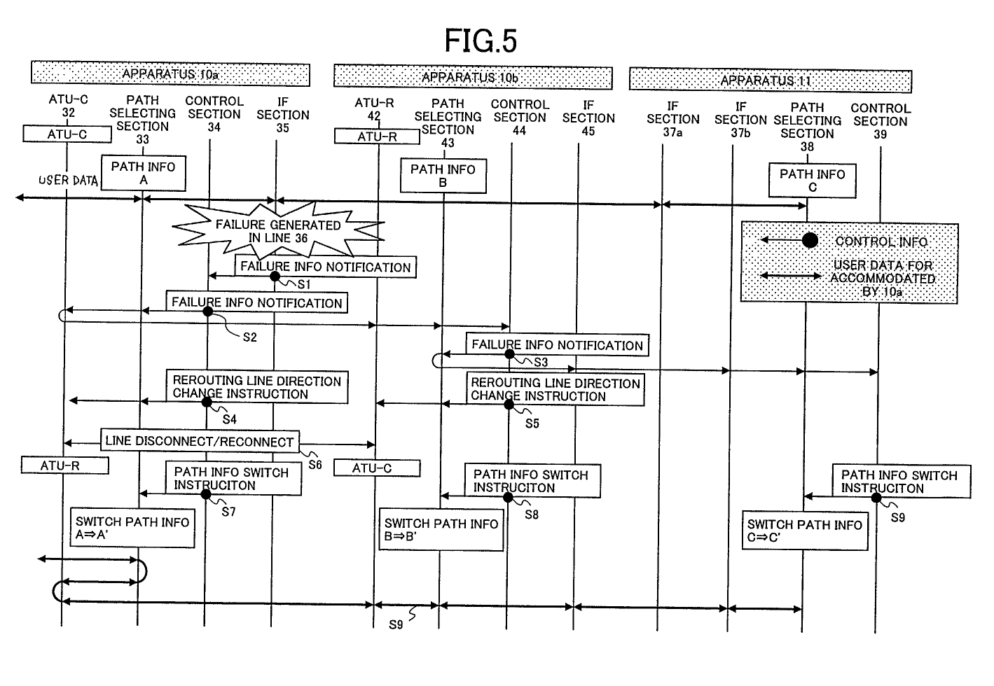

FIG. 5 is a sequence diagram for explaining an embodiment of a transmission line rerouting procedure of the present invention. FIG. 5 shows the transmission rerouting procedure for a case where a failure is generated in the trunk transmission line 36. In a normal state, path information A, B and C for carrying out the routing process is respectively set in the path selecting sections 33, 43 and 38. For example, the data supplied from the xDSL termination section 31a to the path selecting section 33 is routed to the transmission line interface section 35 depending on the path information A.

When a failure is generated in the trunk transmission line 36, the transmission interface section 35 in a step S1 detects this failure generated in the trunk transmission line 36, and notifies transmission line failure information with respect to the control section 34. After the step S1, the control section 34 in a step S2 notifies the transmission line failure information to the control section 44 of the remote xDSL subscriber line accommodating apparatus 10b via the control path utilizing the rerouting transmission line 13. More particularly, the transmission line failure information is notified from the control section 34 to the control section 44 via the path selecting section 33, the xDSL termination section 32, the xDSL termination section 42 and the path selecting section 43.

After the step S2, the control section 44 in a step S3 notifies the transmission line failure information to the control section 39 of the accessing accommodating apparatus 11 via the control path utilizing the trunk transmission line 46. More particularly, the transmission line failure information is notified from the control section 44 to the control section 39 via the path selecting section 43, the transmission line interface section 45, the transmission line interface section 37b and the path selecting section 38.

By the above described process, the control section 34 of the remote xDSL subscriber line accommodating apparatus 10a, the control section 44 of the remote xDSL subscriber line accommodating apparatus 10b, and the control section 39 of the accessing accommodating apparatus 11 recognize the failure generated in the trunk transmission line 36.

When the xDSLs used have an up-transmission rate and a down-transmission rate which are asymmetrical, it is necessary to modify the setting at the center side or the remote side of the rerouting transmission line 13. In a step S4, the control section 34 notifies a direction change instruction to the xDSL termination section 32 to instruct the change in direction of the rerouting transmission line 13. Further, in a step 5, the control section 44 notifies a direction change instruction to the xDSL termination section 42 to instruct the change in direction of the rerouting transmission line 13. By the processes carried out by the steps S4 and S5, the xDSL termination section 32 and the xDSL termination section 42 are switched from the ATU-C mode to the ATU-R mode or, from the ATU-R mode to the ATU-C mode. In a step S6, the rerouting transmission line 13 is temporarily disconnected and thereafter reconnected.

In a step S7, the control section 34 changes the path information A set in the path selecting section 33 to path information A′. In a step S8, the control section 44 changes the path information B set in the path selecting section 43 to path information B′. Moreover, in a step S9, the control section 39 changes the path information C set in the path selecting section 38 to path information C′.

For example, the data supplied from the xDSL termination section 31a to the path selecting section 33 is routed to the xDSL termination section 32 depending on the path information A′ as indicated by the step S9, and the data is supplied to the path selecting section 38 via the xDSL termination section 42, the path selecting section 43, the transmission line interface section 45 and the transmission line interface section 37b.

Next, a more detailed description will be given of a path selection switching process. For example, the path selecting section 33 changes the output port of each user data in the up-direction, input from the xDSL termination sections 31a through 31n, from the transmission line interface section 35 to the xDSL termination section 32. Further, the path selecting section 33 changes the output ports of addresses 1 through n of each of the user data in the down-direction, input from the xDSL termination section 32, to the xDSL termination sections 31a through 31n. As a result, the remote xDSL subscriber line accommodating apparatus 10a can transmit and receive each user data via the rerouting transmission line 13.

The path selecting section 43 sets the output port of each user data in the up-direction, input from the xDSL termination section 42, to the transmission line interface section 45, and changes the addresses 1 through n of each of the user data of the remote xDSL subscriber line accommodating apparatus 10a to addresses m+1 through m+n, so as not to overlap the addresses 1 through m of each of the user data of the remote xDSL subscriber line accommodating apparatus 10b.

In addition, the path selecting section 43 sets the output port of the user data of the addresses m+1 through m+n, input from the transmission line interface section 45, to the xDSL termination section 42, and changes the addresses m+1 through m+n of the user data to the addresses 1 through n. By the above described processes, the remote xDSL subscriber line accommodating apparatus 10b can transmit and receive each user data of the remote xDSL subscriber line accommodating apparatus 10a via the rerouting transmission line 13 and the trunk transmission line 46.

The path selecting section 38 changes the input port of the user data of the remote xDSL subscriber line accommodating apparatus 101 from the transmission line interface section 37a to the transmission line interface section 37b, and changes the addresses 1 through n of each of the user data to the addresses m+1 through m+n. In addition, the path selecting section 38 changes the output port of the user data of the addresses 1 through n, input from the backbone trunk interface section 50, from the transmission line interface section 37a to the transmission line interface section 37b, and changes the addresses 1 through n of each of the user data to the addresses m+1 through m+n. By the above described processes, the accessing accommodating apparatus 11 can transmit and receive each user data of the remote xDSL subscriber line accommodating apparatus 10a via the trunk transmission line 46.

In the transmission line rerouting procedure shown in FIG. 5, the transmission line interface section 35 detects the failure generated in the trunk transmission line 36. However, the failure generated in the trunk transmission line 36 may be detected by the transmission interface section 37a. In this case, the control section 39 notifies the transmission line failure information to the control section of the remote xDSL subscriber line accommodating apparatus 10b via a control path utilizing the trunk transmission line 46. In addition, the controller 44 notifies the transmission line failure information to the control section 34 of the remote xDSL subscriber line accommodating apparatus 10a via a control path utilizing the rerouting transmission line 13.

Moreover, in the transmission line rerouting procedure shown in FIG. 5, it is assumed for the sake of convenience that the failure is generated in the trunk transmission line 36. However, a similar procedure may be carried out when a contention is generated in the trunk transmission line 36. Moreover, it may be seen that a procedure similar to that shown in FIG. 5 may be carried out when a failure or contention is generated in the trunk transmission line 46.

In addition, when selecting a trunk transmission line which is to be rerouted, an abnormality in the trunk transmission line may be detected based on the traffic in each of the trunk transmission lines connecting the trunk transmission line accommodating apparatus (accessing accommodating apparatus) and the subscriber line accommodating apparatuses (remote xDSL subscriber line accommodating apparatuses), so that the trunk transmission line having a large or largest traffic is selected as the trunk transmission line which is to be rerouted.

Further, the present invention is not limited to these embodiments, but various variations and modifications may be made without departing from the scope of the present invention.

What is claimed is:

1. A transmission line rerouting method for rerouting a predetermined trunk transmission line of a plurality of trunk transmission lines of a system in which a plurality of subscriber line accommodating apparatuses respectively accommodating one or more subscriber lines and a trunk transmission line accommodating apparatus accommodating the plurality of subscriber line accommodating apparatuses are coupled via the plurality of trunk transmission lines, comprising the steps of:
(a) selecting the predetermined trunk transmission line to be rerouted, from the plurality of trunk transmission lines;
(b) coupling a first subscriber line accommodating apparatus which is coupled to the predetermined trunk transmission line and a second subscriber line accommodating apparatus which is coupled to a trunk transmission line other than the predetermined trunk transmission line, via a rerouting transmission line; and
(c) transmitting and receiving a first data which is to be exchanged between the first subscriber line accommodating apparatus and the trunk transmission line accommodating apparatus, via the second subscriber line accommodating apparatus and the trunk transmission line other than the predetermined trunk transmission line.

2. The transmission line rerouting method as claimed in claim 1, wherein said step (a) includes:
detecting an abnormality in the trunk transmission lines coupling the trunk transmission line accommodating apparatus and the first and second subscriber line accommodating apparatuses.

3. The transmission line rerouting method as claimed in claim 1, wherein said step (a) includes:
detecting a traffic in each of the trunk transmission lines coupling the trunk transmission line accommodating apparatus and the first and second subscriber line accommodating apparatuses; and
selecting a trunk transmission line having a large or largest traffic as the predetermined trunk transmission line.

4. The transmission line rerouting method as claimed in claim 1, wherein said step (b) couples the first and second subscriber line accommodating apparatuses via one or more subscriber lines.

5. The transmission line rerouting method as claimed in claim 1, wherein said subscriber lines are made of xDSLs.

6. A subscriber line accommodating apparatus for accommodating one or a plurality of subscriber lines, comprising:
trunk transmission line coupling means for coupling trunk transmission lines to a trunk transmission line accommodating apparatus which accommodates one or a plurality of subscriber line accommodating apparatuses; and
transfer means for monitoring a state of the trunk transmission lines and transferring a first transmitting data which is to be transmitted to the trunk transmission line accommodating apparatus to an other subscriber line accommodating apparatus depending on a monitored result, so that a first receiving data which is to be received from the trunk transmission line accommodating apparatus is transferred from said other subscriber line accommodating apparatus.

7. The subscriber line accommodating apparatus as claimed in claim 6, wherein said transfer means transfers a second transmitting data in place of the first transmitting data to the trunk transmission line accommodating apparatus when the second transmitting data which is to be transmitted to the trunk transmission line accommodating apparatus is transferred from said other subscriber line accommodating apparatus, and a second receiving data is transferred to said other subscriber line accommodating apparatus when the second receiving data which is to be received by said other subscriber line accommodating apparatus is received from the trunk transmission line accommodating apparatus in place of the first receiving data.

8. The subscriber line accommodating apparatus as claimed in claim 6, which is coupled to said other subscriber line accommodating apparatus via one or a plurality of subscriber lines.

9. The subscriber line accommodating apparatus as claimed in claim 8, wherein the one or plurality of subscriber lines are made of xDSLs.

10. The subscriber line accommodating apparatus as claimed in claim 6, wherein the one or plurality of subscriber lines are made of xDSLs.

11. A trunk transmission line accommodating apparatus for accommodating one or a plurality of subscriber line accommodating apparatuses, comprising:
trunk transmission line coupling means for coupling to the one or plurality of subscriber line accommodating apparatuses respectively accommodating one or more subscriber lines via one or more trunk transmission lines; and
transmitting and receiving means for monitoring a state of the one or more trunk transmission lines and transferring a transmitting data which is to be transmitted to a first subscriber line accommodating apparatus to a second subscriber line accommodating apparatus depending on a monitored result, so that a receiving data which is to be received from the first subscriber line accommodating apparatus is received from the second subscriber line accommodating apparatus.

12. The trunk transmission line accommodating apparatus as claimed in claim 11, wherein said trunk transmission line coupling means monitors an abnormality or a traffic of the one or more trunk transmission lines.

13. The trunk transmission line accommodating apparatus as claimed in claim 11, wherein the one or more subscriber lines are made of xDSLs.
